(19) United States
(12) Patent Application Publication
(10) Pub. No.: US 2005/0126634 A1
(43) Pub. Date: Jun. 16, 2005

(54) Water level indicating device for a dishwasher

(76) Inventors: Jorge Luiz Benine Penteado, Sao Carlos (BR); Antonio Carlos Martins, Santos (BR); Sntonio de Oliveira, Rio Claro (BR); Clebor Bombam, Piraciaba (BR); Gilberto Moreto, Rio Claro (BR); Jaime Moreira, Rio Claro (BR); Jose Carlos Stabellini, Rio Claro (BR); Micael Zirondi, Rio Claro (BR); Reinaldo Degea, Rio Claro (BR)

Correspondence Address: DARBY & DARBY P.C., P. O. BOX 5257, NEW YORK, NY, 10150-5257, US

(21) Appl. No.: 10/468,521

(22) PCT Filed: Feb. 7, 2002
(86) PCT No.: PCT/BR02/00022

(30) Foreign Application Priority Data
Feb. 15, 2001 (BR) PI01007165

(51) Int. Cl. F16K 31/18

(52) U.S. Cl. 137/412

(57) ABSTRACT

A water level indicating device for a dishwasher provided with a cabinet, inside which is placed a washer tub (1), and presenting a control unit, which determines the operational conditions of providing or interrupting the water supply to the inside of the washer tub (1), said device comprising: a first chamber (10) in fluid communication with the washer tub (1); a second chamber (20) having a lower portion (21) maintained in fluid communication with a lower portion (11) of the first chamber (10); and a level sensor (2), which is operatively associated with both the second chamber (20) and the control unit, in order to inform the latter about a water level detected inside said second chamber (20) and corresponding to a desired filling level of the washer tub (1).

### FIELD OF THE INVENTION

The present invention refers to a water level indicating device for a dishwasher, particularly to be applied in small and medium size dishwashers.

### PRIOR ART

Dishwashers have a cabinet, which is usually parallelepipedic and closed by a vertical door, and inside which is mounted a washer tub designed to receive a determined quantity and type of dishes to be cleaned. For the washing operation, after closing the door and starting the washing operation, the washer tub is filled with water, up to a certain predetermined filling level, which, when achieved, is informed to a control unit that commands the interruption of water supply to the dishwasher.

The small and medium size dishwashers present, mounted inside the cabinet and adjacent and external to the washer tub, a level sensor in fluid communication with said washer tub through a duct arranged in a vessel communicating system. In the known constructions, the level sensor is mounted to a float provided inside a level duct in fluid communication with the washer tub and which is disposed substantially vertical, parallel and adjacent to a rear wall of said washer tub, said level duct having a lower end opened to a lower portion of the washer tub, in order to receive the filling water for the latter, and a vented upper end, through which is mounted the float with the level sensor.

In these constructions, the level sensor informs the control unit when a predetermined water level has been achieved inside the washer tub, allowing said control unit to start the washing operation. In such constructions, the level sensor may also, for example, inform the control unit about a minimum water level, indicating that either the washer tub has been drained, or, in a filling condition, that the minimum water level has not been achieved to allow the washing operation to start.

In these dishwashers, the grease of the dishes contained in the washing water inside the washer tub also reaches the level duct where the level sensor is located, impregnating in these elements and gradually interfering with the adequate operation of the level sensor, or even causing operational defects in the float that carries said level sensor.

### SUMMARY OF THE INVENTION

Thus, it is an object of the present invention to provide a water level indicating device for a dishwasher, which minimizes the contact of the level sensor with the impurities existing in the washing liquid, particularly grease, thus preventing the inadequate operation of the float that carries said level sensor and consequently of said level sensor and said dishwasher.

A more specific object of the present invention is to provide a water level indicating device, such as that mentioned above which, in case of failure of its level sensor, prevents the dishwasher from working when the latter does not present effective operational conditions, for example, due to insufficient water therein.

These and other objectives are achieved by a water level indicating device for a dishwasher having a cabinet, inside which is provided a washer tub, and presenting a control unit, which determines the operational conditions of providing or interrupting the water supply to the inside of the washer tub, said device comprising: a first chamber, in fluid communication with the washer tub; a second chamber, having a lower portion maintained in fluid communication with a lower portion of the first chamber; and a level sensor, which is operatively associated with both the second chamber and the control unit, in order to inform said control unit about a water level detected inside said second chamber and corresponding to a desired filling level of the washer tub.

### BRIEF DESCRIPTION OF THE DRAWINGS

The following invention will be described below, with reference to the attached drawings, in which:

FIG. 1 illustrates a longitudinal sectional view of an embodiment of the water level indicating device for a dishwasher of the present invention, to be mounted inside the cabinet of the dishwasher, externally to the washer tub thereof and carrying two floats therewithin;

FIG. 2 is an upper view of the embodiment for the water level indicating device illustrated in FIG. 1, without the cover upper portion of said device;

FIG. 3 is a perspective view of the device of FIG. 2;

FIG. 4 is a perspective view of a chamber divider of the device of the present invention;

FIG. 5 is a perspective view of the cover of the present device; and

FIGS. 6 and 7 illustrate a perspective view of each float with the respective level sensor of the device of the present invention.

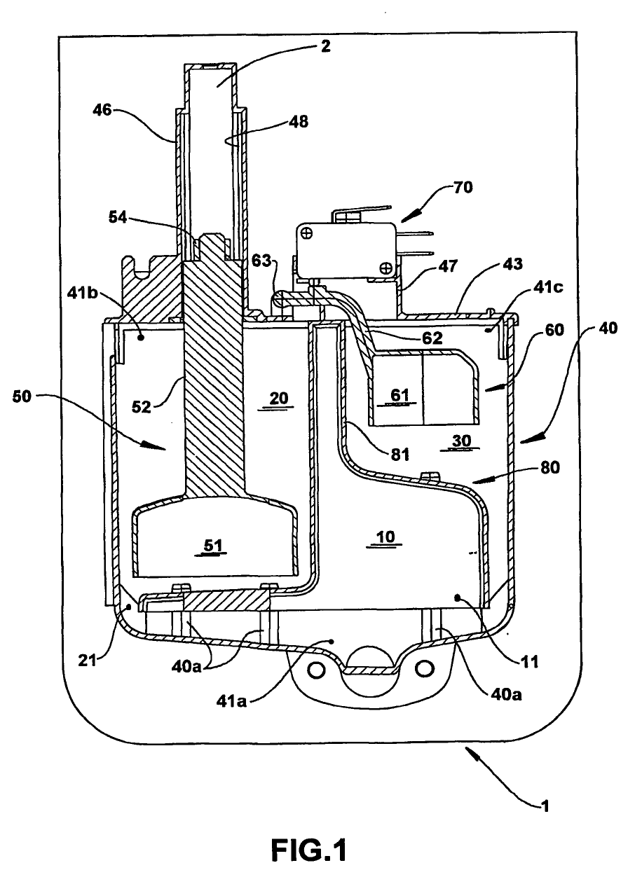

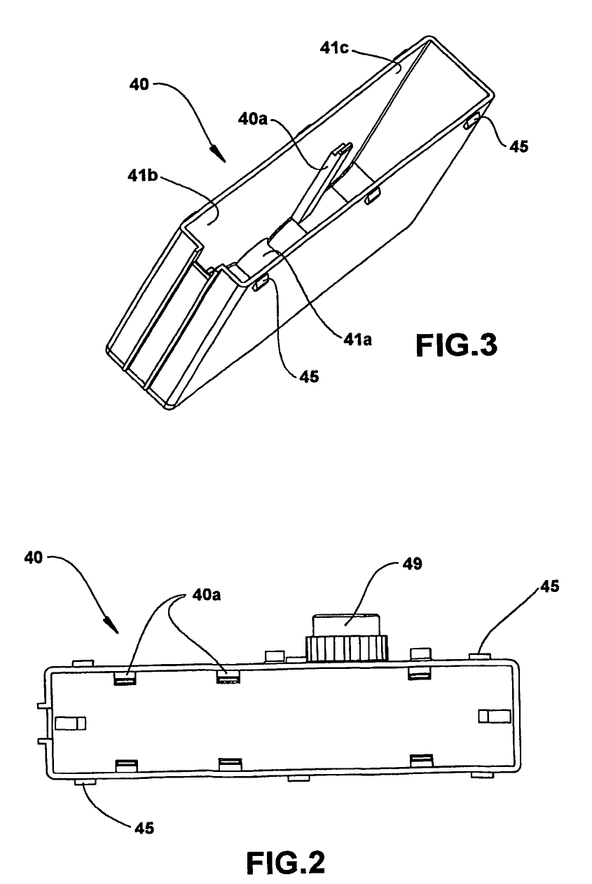

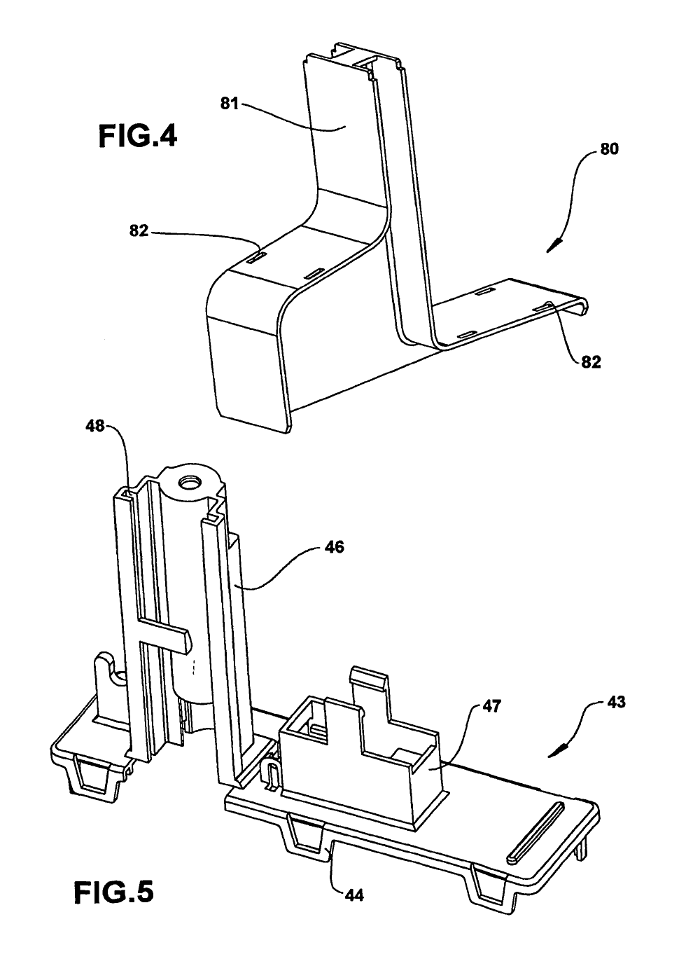

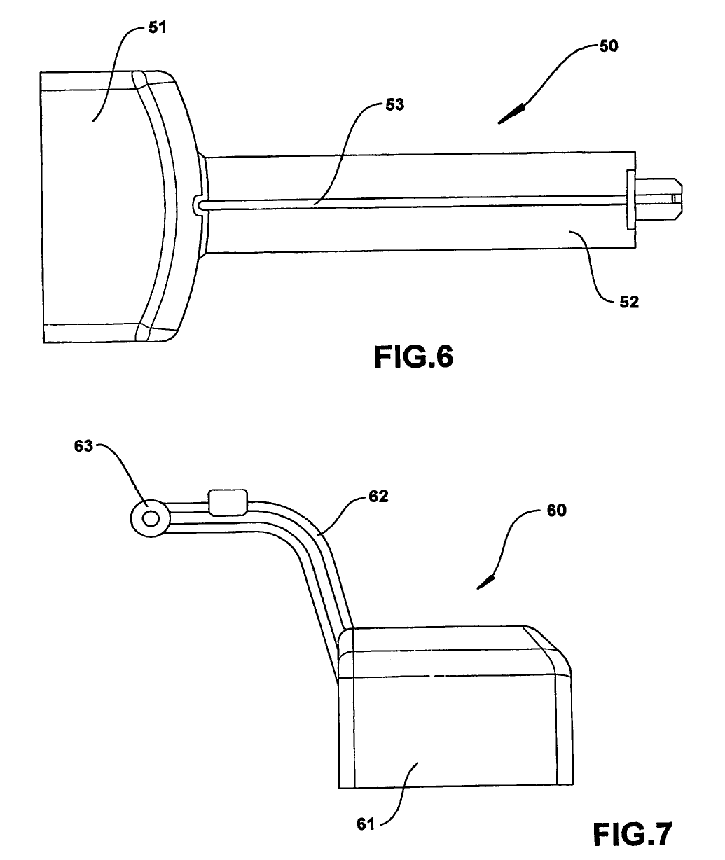

### DESCRIPTION OF THE ILLUSTRATED EMBODIMENT

The present invention will be described in relation to a small or medium size dishwasher of the type comprising, inside a non-illustrated cabinet, a washer tub 1, which receives the dishes to be cleaned, and external and adjacent to said washer tub, and inside the cabinet, the water level device of the present invention.

The dishwasher further comprises a control unit, not illustrated, which determines the operational conditions for providing and interrupting the water supply to the inside of the washer tub 1, based on the information received from a level sensor 2, provided inside the present device, as described below and which indicates when the filling water of the dishwasher achieves a determined level in said water level indicating device corresponding to a certain water level within the washer tub 1. Upon receiving this information from the level sensor 2, the control unit commands the interruption of water supply to the washer tub 1 and the start of the washing operation. In a possible option, the level sensor 2 further informs the control unit when the water inside the device of the present invention achieves a minimum water level, indicating the washer tub 1 has been drained and that it may thus be refilled.

According to the present invention, the water level indicating device of the present invention comprises a first chamber 10 in fluid communication with the washer tub 1, and a second chamber 20, having a lower portion 21 maintained in fluid communication with a lower portion 11 of the first chamber 10 and to which are operatively associated the level sensor 2 and the control unit, so that the level sensor 2 detects and informs said control unit about at least one water level, which is previously defined and achieved by the water being supplied to the inside of said second chamber 20 corresponding to a respective and desired filling level of the washer tub 1.

The level sensor 2 is displaceable inside the second chamber 20 between a first position and a second position, which are axially spaced form each other and respectively correspond to the conditions of presence of water inside the second chamber 20, below and on a certain predetermined filling level of said second chamber 20.

In the illustrated constructive option, the water level indicating device comprises a hollow body 40, inside which are defined at least two, for example three chambers 10, 20, 30, in fluid communication with each other and with the washer tub 1, as described below, said hollow body 40 presenting a first end 41a, opened to the washer tub 1 and providing fluid communication with the latter and with the first chamber 10, and a second end 41b, vented to the atmosphere and whereto is mounted the level sensor 2. In the illustrated constructive option, the hollow body 40 is coupled to the washer tub 1 through its first end 41a and receives, through its second end 41b, a first float 50, which is displaceable inside the second chamber 20 and carries the level sensor 2, and, through a third end 41c, a second float 60 actuating inside the third chamber 30, and a safety sensor 70 associated with said second float 60. The safety sensor 70 is provided inside the third chamber 30 in a vertical higher position than that of the level sensor 2 in its position corresponding to a maximum filling condition of the washer tub 1, so as to inform the control unit that a maximum filling limit of the washer tub 1 has been achieved.

Each float is made of plastic material, for example. The first float 50 carries a magnetic element, such as a magnet, which allows its movement in the respective chamber.

In the illustrated construction, the hollow body 40 is closed by a cover 43 carrying both the level sensor 2 and the safety sensor 70 and which is affixed to the hollow body 40, closing the latter by fitting each of a plurality of ears 44 provided in a lower skirt portion of said cover 43, into a corresponding tooth 45 provided in an upper portion of the hollow body 40. In this construction, the cover 43 presents, from an external face thereof, first and second vented tubular projections 46, 47, said first tubular projection 46 lodging the first float 50 and the level sensor 2 and said second tubular projection 47 lodging the safety sensor 70 and the second float 60.

The first float 50 presents a buoy portion 51 and a rod portion 52 projecting from said buoy portion 51 and provided with grooves 53, for example orthogonal to each other, a free end of said rod portion 52 presenting a magnet 54 and said second float 60 comprising a respective buoy 61 and an arm 62 projecting from an upper end edge of the respective buoy 61 and presenting, for example, a curved shape, particularly spacing away from said buoy 61, said arm 62 being articulated by an end 63 to a portion of the second tubular projection 47.

The first tubular projection 46 presents, internally along its length, at least one pair of longitudinal guides 48, which are for example, continuous and opposite to each other, and which will receive respective grooves 53 of the rod portion of the first float 50, in order to avoid that, when water is supplied to and drained from said chamber 20, said first float 50 presents other movements than the vertical displacement to and from said first tubular projection 46.

The safety sensor 70 is mounted to the vented portion of the second tubular projection 47 of the cover 43 and is actuated by a switch, whose operation is defined as a function of the movement of the second float 60 inside the third chamber 30.

According to the illustrated constructive option, the hollow body 40 of the water level indicating device 10 of the present invention carries a divider 80, for example in a single piece mounted inside said hollow body 40, in order to define therein the first, the second and the third chambers 10, 20 and 30, said first chamber 10 being positioned between the other chambers and having its lower portion opened to the first end 41a of the hollow body 40. As a function of the construction of the divider 80, the latter defines, for each chamber of the hollow body 40, a respective lower opening on the same level inside the hollow body 40.

The hollow body 40 presents, internally, in a lower portion of each lateral wall, internal projections 40a, which define guides for the introduction and fixation of the divider 80. In the illustrated construction, each lateral wall includes three internal projections 40a, one of each being vertically longer and determining the support for the portion of the divider 80 that defines the third chamber 30.

The hollow body 40 presents a bottom wall with a “V” profile, in order to allow water to be drained when said hollow body 40 is emptied. In the vertex region of said “V” profile is provided a lateral nozzle 49 located in the hollow body 40 and which is opened to the first end 41a, for example being tooted and receiving a sealing ring, not illustrated, for mounting the present device to the washer tub 1.

The divider 80 presents a flat central structure, from which upper contour project, to each side of said structure, flanges 81 provided with holes 82, each hole for receiving a fitting end of an internal projection 40a provided in an internal lateral wall of the hollow body 40.

In a way of carrying out the present invention, the level sensor 2 is a magnetic sensor and the safety sensor 70 is an electrical switch, said sensors being provided in order to, respectively, detect a minimum water level and a maximum water level in the dishwasher, and each sensor being mounted on a respective printed circuit board provided in the cover 43 of the hollow body 40 of the present device.

The safety sensor 70 operates independently of the level sensor 2, preventing the water from flowing out of the dishwasher in case the level sensor 2 fails to detect the water level. After receiving the information from said safety sensor 70 that the water level has reached a predetermined maximum value and, therefore, indicating the operation of the level sensor 2 has failed, the control unit commands the deenergization of a water inlet valve and the energization of a drainage pump, for promoting the partial or total emptying of the washer tub 1. In the illustrated construction, the water supply and water discharge in the hollow body 40 is made through the same opening, represented by the first end 41a of said hollow body 40.

The device of the present invention minimizes reading errors of the water levels and reduces risks of water overflowing from said washer tub 1.

1. A water level indicating device for a dishwasher provided with a cabinet, inside which is placed a washer tub (1), and presenting a control unit, which determines the operational conditions of providing or interrupting the water supply to the inside of the washer tub (1), characterized in that it comprises:
a first chamber (10) in fluid communication with the washer tub (1);
a second chamber (20) having a lower portion (21) maintained in fluid communication with a lower portion (11) of the first chamber (10); and
a level sensor (2), which is operatively associated with both the second chamber (20) and the control unit, in order to inform said control unit about a water level detected inside said second chamber (20) and corresponding to a desired filling level of the washer tub (1).

2. Device, according to claim 1, characterized in that it comprises a hollow body (40) defining, internally, first and second chambers (10, 20), said hollow body (40) presenting a first end (41a) opened to the washer tub (1) and providing fluid communication between the latter and the first chamber (10).

3. Device, according to claim 2, characterized in that the hollow body (40) presents a vented second end (41b), whereto is mounted the level sensor (2), which is defined in the second chamber (20) spaced from the lower portion of the latter that is in fluid communication with the first chamber (10).

4. Device, according to claim 1, characterized in that the level sensor (2) is displaceable inside the second chamber (20) between a first position and a second position, which are axially spaced from each other and respectively correspond to the conditions of presence of water in the second chamber (20), below and on a certain predetermined filling level of said second chamber (20).

5. Device, according to claim 4, characterized in that the level sensor (2) is mounted to a first float (50), provided inside the second chamber (20).

6. Device, according to claim 1, characterized in that the hollow body (40) is coupled to the washer tub (1) through its first end (41a).

7. Device, according to claim 6, characterized in that the first and the second chambers (10, 20) are separated from each other by a divider (80) carried by the hollow body (40).

8. Device, according to claim 7, characterized in that the divider (80) is a piece mounted inside the hollow body (40) defining inside the latter the first and the second chambers (10, 20).

9. Device, according to claim 6, characterized in that it includes a safety sensor (70) provided in a third chamber (30) having a respective lower portion in fluid communication with the first chamber (10) through a lower opening in the latter, said safety sensor (70) being operatively associated with both the control unit and said third chamber (30), in order to detect the water level existing therein, informing this detected level to the control unit.

10. Device, according to claim 9, characterized in that the safety sensor (70) is mounted to a second float (60) provided in said third chamber (30), said safety sensor (70) being actuated when the washing liquid inside said third chamber (30) reaches a level in the latter that is higher than that level actuating the level sensor (20).

11. Device, according to claim 9, characterized in that the third chamber (30) is defined in the hollow body (40) by the divider (80) and that said third chamber (30) is positioned in said hollow body (40) in order to have a common wall with the first chamber (10).

12. Device, according to claim 9, characterized in that the hollow body (40) is superiorly closed by a cover (43), through which is mounted at least one of the level sensor (2) and safety sensor (70).

13. Device, according to claim 12, characterized in that the cover (43) carries a first and a second tubular projection (46, 47) for respectively mounting the first and the second floats (50, 60).
